(19) United States
(12) Patent Application Publication
(10) Pub. No.: US 2024/0420046 A1
(43) Pub. Date: Dec. 19, 2024

(54) HYPERLOCAL WEATHER STATION AND METHODS FOR EFFICIENTLY SCHEDULING ROAD CONSTRUCTION PROJECTS

(71) Applicant: Pavewise, Inc., Bismarck, ND (US)

(72) Inventor: Bryce Wuori, Bismarck, ND (US)

(21) Appl. No.: 18/639,438

(22) Filed: Apr. 18, 2024

Related U.S. Application Data
(63) Continuation-in-part of application No. 18/479,740, filed on Oct. 2, 2023.
Application No. 18/479,740 is a continuation-in-part of application No. 18/446,467, filed on Aug. 8, 2023.
Application No. 18/446,467 is a continuation-in-part of application No. 18/334,252, filed on Jun. 13, 2023.

(51) Int. Cl. G06Q 10/0631; G06Q 50/08

(52) U.S. Cl. CPC G06Q 10/06313; G06Q 50/08

(57) ABSTRACT

A computer implemented method for identifying weather related productivity impact events to a road construction project includes positioning one or more local weather stations at a particular geographic location that is the subject of a road construction project; receiving, at one or more processors, weather data from the one or more local weather stations; comparing, at the one or more processors, the received weather data with one or more predetermined weather limits; generating, using the one or more processors, one or more notifications specifying one or more predetermined weather limits violated by the received weather data; and communicating the one or more notifications to a user associated with the road construction projects.

### CROSS REFERENCE TO RELATED APPLICATION[S]

The present disclosure is a continuation-in-part of U.S. patent application Ser. No. 18/479,740 filed Oct. 2, 2023 (01959-PAV) which is a continuation-in-part of U.S. patent application Ser. No. 18/446,467 filed Aug. 8, 2023 (01948-PAV) which is a continuation-in-part of U.S. patent application Ser. No. 18/334,252 filed Jun. 13, 2023 (01879-PAV).

### BACKGROUND

The present disclosure relates to systems and methods for efficiently scheduling road construction projects.

Road construction projects may often involve coordination between multiple construction entities and regulatory bodies. Construction entities rely on schedules of activities to ensure projects/activities are completed on-time, that resources such as materials, personnel and equipment are at the right place at the right time, and that activities are completed in the proper sequence.

The construction entities must maintain project quality while being as efficient

as possible irrespective of current and future weather conditions. In practice, a construction entity may shut down a construction site in response to inclement weather which reduces efficiency and potential monetary bonuses typically paid should the road construction project be completed on time.

### SUMMARY

A computer implemented method for identifying weather related productivity impact events to a road construction project according to one disclosed non-limiting embodiment of the present disclosure includes positioning one or more local weather stations at a particular geographic location that is the subject of a road construction project; receiving, at one or more processors, weather data from the one or more local weather stations; comparing, at the one or more processors, the received weather data with one or more predetermined weather limits; generating, using the one or more processors, one or more notifications specifying one or more predetermined weather limits violated by the received weather data; and communicating the one or more notifications to a user associated with the road construction projects.

A further embodiment of any of the foregoing embodiments of the present disclosure includes that the received weather data comprises at least one of solar radiation, precipitation, max air temperature, minimum air temperature, barometric pressure, vapor pressure, relative humidity, wind speed, wind direction, maximum wind gust.

A further embodiment of any of the foregoing embodiments of the present disclosure includes logging the predetermined weather limits violated by the received weather data.

A further embodiment of any of the foregoing embodiments of the present disclosure includes parsing the received weather data with respect to a type of road application.

A further embodiment of any of the foregoing embodiments of the present disclosure includes that the type of road application comprises one of asphalt, pavement, or dirt road grading.

A further embodiment of any of the foregoing embodiments of the present disclosure includes that the predetermined weather limits are set by a regulatory agency.

A further embodiment of any of the foregoing embodiments of the present disclosure includes that the predetermined weather limits are scraped from a third-party data source.

A further embodiment of any of the foregoing embodiments of the present disclosure includes that the predetermined weather limits comprise at least one of a local, state, or federal regulatory agency.

A further embodiment of any of the foregoing embodiments of the present

disclosure includes that the predetermined weather limits are stored in a database in communication with the one or more processors.

A further embodiment of any of the foregoing embodiments of the present disclosure includes visually recording weather data from the one or more local weather stations.

A further embodiment of any of the foregoing embodiments of the present disclosure includes that the notifications comprise identification of the one or more predetermined weather limits that are violated by the received weather data.

A system for identifying weather related productivity impact events to a road construction project according to one disclosed non-limiting embodiment of the present disclosure includes a local weather station at a particular geographic location that is the subject of a road construction project; a database operable to store predetermined weather limits set by a regulatory agency for the road construction project; and a server located at a location remote from the road construction project, the server runs a proactive road construction recommendations application that communicates with the local weather station and the database to processes weather information from the local weather station to identify one or more predetermined weather limits violated by the received weather data.

A further embodiment of any of the foregoing embodiments of the present disclosure includes a client-facing website to provide advanced notice of weather events and directions for modifying one or more productivity variables associated with the road construction project in response to the projected weather.

A further embodiment of any of the foregoing embodiments of the present disclosure includes a client-facing mobile app to provide advanced notice of weather events and directions for modifying one or more productivity variables associated with the road construction project in response to the projected weather.

A further embodiment of any of the foregoing embodiments of the present disclosure includes that the local weather station comprises a camera.

The foregoing features and elements may be combined in various combinations without exclusivity, unless expressly indicated otherwise. These features and elements as well as the operation thereof will become more apparent in light of the following description and the accompanying drawings. It should be appreciated that however the following description and drawings are intended to be exemplary in nature and non-limiting.

### BRIEF DESCRIPTION OF THE DRAWINGS

Various features will become apparent to those skilled in the art from the following detailed description of the disclosed non-limiting embodiment. The drawings that accompany the detailed description can be briefly described as follows:

FIG. 1 is a schematic view of a system that determines proactive recommendations for efficiently performing road construction projects in response to forecasted weather events according to one disclosed non-limiting embodiment.

FIG. 2 is a schematic block diagram view of a high-level architecture of a system that determines proactive recommendations for efficiently performing road construction projects in response to forecasted weather events according to one disclosed non-limiting embodiment.

FIG. 3 is a schematic block diagram view of a weather application programming interface according to one disclosed non-limiting embodiment.

FIG. 4 is an example screen view of a client facing website page.

FIG. 5 is a schematic block diagram view of a productivity recommendation according to one disclosed non-limiting embodiment.

FIG. 6 is a schematic block diagram view of an ambient air temperature module that ranks a temperature range from a productivity forecast engine according to one disclosed non-limiting embodiment.

FIG. 7 is a schematic block diagram view of a moisture module that ranks a moisture range from the productivity forecast engine according to one disclosed non-limiting embodiment.

FIG. 8 is a schematic block diagram view of a wind speed module that ranks a wind speed range from the productivity forecast engine according to one disclosed non-limiting embodiment.

FIG. 9 is a schematic block diagram of a method for modifying one or more productivity variables associated with a road construction project in response to forecasted weather events via the proactive road construction recommendations application.

FIG. 10 is a schematic block diagram view of an employee diagnostics module that ranks employee condition from the productivity forecast engine according to one disclosed non-limiting embodiment.

FIG. 11 is a schematic block diagram of a method for modifying one or more productivity variables associated with a road construction project in response to the employee diagnostics module via the proactive road construction recommendations application.

FIG. 12 is an example screen view of an app page that communicates with an employee.

FIG. 13 is a schematic block diagram of a method for determining an impact over a predetermined time period associated with a road construction project in response to forecasted weather events via the proactive road construction recommendations application.

FIG. 14 is a screen view that communicates a daily and an overall impact of the received weather forecast data over a predetermined time period of 7 days.

FIG. 15 is a screen view of a calendar view that communicates a daily impact of the received weather forecast data over a predetermined time period of 14 days.

FIG. 16 is a chart illustrating the determination of the impact of the received weather forecast data over a predetermined time period of 7 days.

FIG. 17 is a schematic block diagram of a method for determining weather related productivity impact events to a road construction project according to one disclosed embodiment.

### DETAILED DESCRIPTION

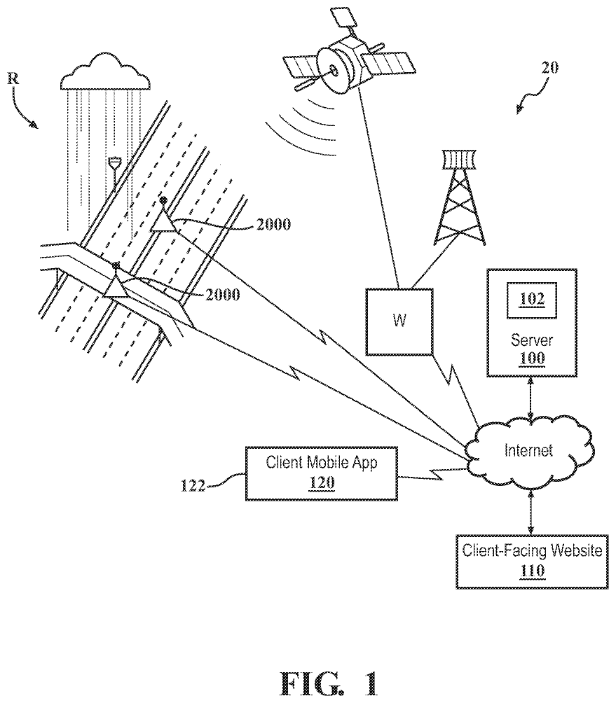

FIG. 1 schematically illustrates a system 20 that determines proactive recommendations for efficiently performing road construction projects in response to forecasted weather events based on inputs of weather, location, equipment, etc. The system 20 is disclosed with respect to an example road construction project R.

The system 20 generally includes a server 100 located at a location remote from the road construction project R, a client-facing website 110, and/or a client-facing mobile app 120 on a handheld device 122. The server 100 runs a proactive road construction recommendations application 102 that communicates with a weather forecasting service W that then processes the weather information to generate one or more notifications specifying modified productivity variables associated with the road construction project that are communicated with the client-facing website 110, and/or the client-facing mobile app 120 to provide advanced notice of weather events and directions for modifying one or more productivity variables associated with the road construction project in response to the projected weather as further described below.

In one embodiment, one or more local weather stations 2000 are located at the example road construction project R. In one example, the local weather stations 2000 may be a METER certified weather station such as an ATMOS 41W model. The local weather station 2000 assure an accurate on-the-site weather determination with a radius of, for example, 5 miles. The local weather stations 2000 may communicate directedly, via the internet, with the server 100 that runs the proactive road construction recommendations application 102 to provide a self-contained system which need not utilize 3^{rd} party weather data.

The local weather stations 2000 may communicate, for example, via an LTE signal (long-term evolution (LTE)) cellular, wireless, satellite, or other communication protocols. The local weather stations 2000 may provide updates at any desired frequency, for example, every 15 minutes. The local weather stations 2000 may provide real time on-the-site environmental variable data, including, for example, solar radiation, precipitation, air temperature (min, max, average), barometric pressure, vapor pressure, relative humidity, wind speed, wind direction, maximum wind gust, etc. The local weather stations 2000 may additionally include cameras, such as a visual, infrared, image intensification, etc., to monitor progress as well as provide real time display of visibility such as may be impacted by fog, snow, etc. The local weather stations 2000 may additionally include sensors to record ground temperature and/or moisture individually and/or in aggregate piles. That is, piles of materials which are located on site may also be tracked. Other sensors such as AI cameras and density sensors/gauges may alternatively or additionally communicate with the local weather stations 2000.

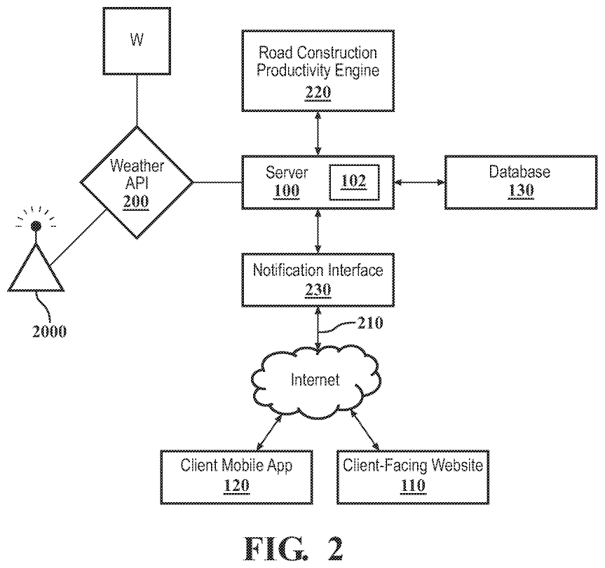

With reference to FIG. 2, the server 100 which runs the proactive road construction recommendations application 102, may be in communication with the client-facing website 110 and the client-facing mobile app 120. A database 130, a weather application programming interface 200 in communication with the weather forecasting service W, the client input data 210 from the client-facing website 110 and/or the client-facing mobile app 120, a productivity forecast engine 220, and a notification interface 230 may communicate with and/or be integrated or hosted by the server 100. The proactive road construction recommendations application 102 generates notifications to users to generate user tailored productivity recommendations specifying modified productivity variables associated with the road construction project to increase efficiency and safety of operations.

The server 100 may include computing device hardware (e.g., servers, processors, processing devices, etc.) and/or software that provide data and computation functionality services to programs, models, and devices via a request-response methodology. The server 100 may comprise memory storing computer executable programs, such as the proactive road construction recommendations application 102, executed by one or more processors to implement the functionality described herein. The server 100 may also include communications interfaces with external components. The term “server” conveys its customary meaning that provides service and/or data connection to, for example, the client-facing website 110, and/or the client-facing mobile app 120.

The server 100 utilizes the notification interface 230 to communicate with the client-facing website 110, and/or the client-facing mobile app 120 through any desired method of communications, including, for example, an SMS, MMS, cellular, GSM, CDMA, Wi-Fi, Wi-Max, wireless transmission, the Internet, LAN, WAN, email, telephone, and any wired or wireless paths or combinations thereof. The term “handheld device” refers to a portable electronic device that is at least configured to send messages to, and/or receive messages from the listing recommendation server over a long-range wireless communication network, such as a SMS, wireless, or cellular network. Examples of handheld devices include, but are not limited to: a mobile phone; a tablet; a portable computer, etc.

The client-facing website 110 may be a website published on a web server and available publicly via the internet. Alternatively, or in addition, the client-facing website 110 may be configured to include private access to the particular clients, via, for example, a password protected section to communicate client input data 210.

The client-facing mobile app 120 may be a client facing mobile software application configured to communicate with the server 100 to communicate client input data 210. The client-facing mobile app 120 may be installed on the handheld device 122.

The database 130 may be an organized collection of data that includes database management systems that allow for manipulation of data through update and retrieval for use by the server 100. The database 130 may store current and historical data associated with one or more road construction projects R to facilitate proactive recommendations for efficiently performing road construction projects.

In one embodiment, the database 130 may store local, state, federal, and/or international standards and codes for predetermined weather limits during construction projects. These predetermined weather limits often change every year-often due to the vicissitudes of the regulatory agency. The local, state, federal, and/or international standards may be scraped, searched, or otherwise referenced for use by the proactive road construction recommendations application 102 via for example, storage in the database 130. The weather application programming interface 200 is in communication with the weather forecasting service W, which can be a source of weather forecast data that provides current and future weather forecasts. The weather application programming interface 200 may include hardware (e.g., servers, processors, processing devices, etc.) and/or software that may be usable by the proactive road construction recommendations application 102 to communicate with the weather forecasting service W to obtain data based on the geographic location of the road construction project R. The weather forecasting service W may include local, national and international weather forecasting sources. For example, weather data collected by doppler radar, radiosondes, weather satellites, buoys and other instruments collect data that are fed into computerized numerical forecast models. The models use equations, along with new and past weather forecast data, to provide weather forecast data.

The productivity forecast engine 220 may include hardware (e.g., servers, processors, processing devices, etc.) and/or software that may include training, learning, and/or other computer models usable by the proactive road construction recommendations application 102 to provide direction regarding the modification and recommendation associated with one or more productivity variables for the road construction project in response to the projected weather as further described below. The productivity forecast engine 220 may be configured to communicate with and/or be integrated or hosted by the server 100.

The notification interface 230 may include hardware (e.g., servers, processors, processing devices, etc.) and/or software usable by the proactive road construction recommendations application 102 that provides client facing notification services via email, text message, automated voice message, laptop/desktop push notification systems, mobile push notification systems, mobile application or “app” notification systems, and/or push notification systems, which can include alerts, badge application icons, banners, sounds/tones, etc. The notification interface 230 may be configured to communicate with and/or be integrated or hosted by the server 100. The notification interface 230 may produce notifications in response to the productivity forecast engine 220. In one embodiment, the notification interface 230 may produce notifications based on the severity of the weather as determined by the weather application programming interface 200 and generate notifications at predetermined time periods and repeat rates. That is, the more severe the weather forecast data as determined by the weather application programming interface 200, the more frequently the notifications are produced and pushed to the client-facing website 110, and/or the client-facing mobile app 120.

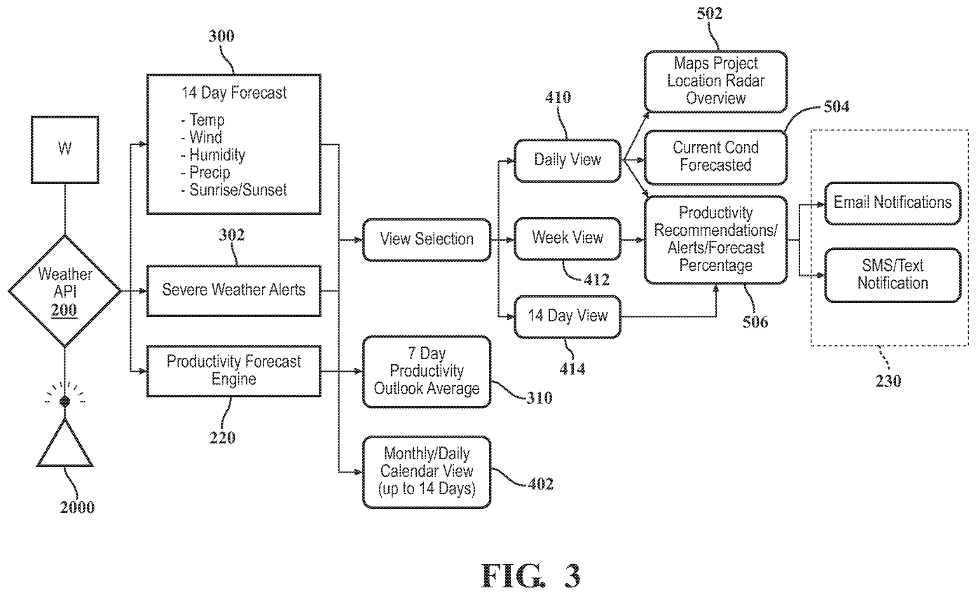

With reference to FIG. 3, the weather application programming interface 200 is in communication with the weather forecasting service W to receive weather forecast data to determine a predicted weather condition change on the road construction project by parsing the weather forecast data via the proactive road construction recommendations application 102.

In one embodiment, the weather application programming interface 200 receives weather data directly from the one or more local weather stations 2000 from each example road construction project R. That is, the local weather stations 2000 provide real time on-the-site environmental variable data.

The weather application programming interface 200, in one embodiment, may generate a 14-day forecast 300 and severe weather alerts 302. The 14-day forecast 300 may track particular weather events such as temperature, wind, humidity, precipitation, sunrise/sunset times, etc. The severe weather alerts 302 may be weather forecast data that supersedes and/or requires particular attention outside of the 14-day forecast 300.

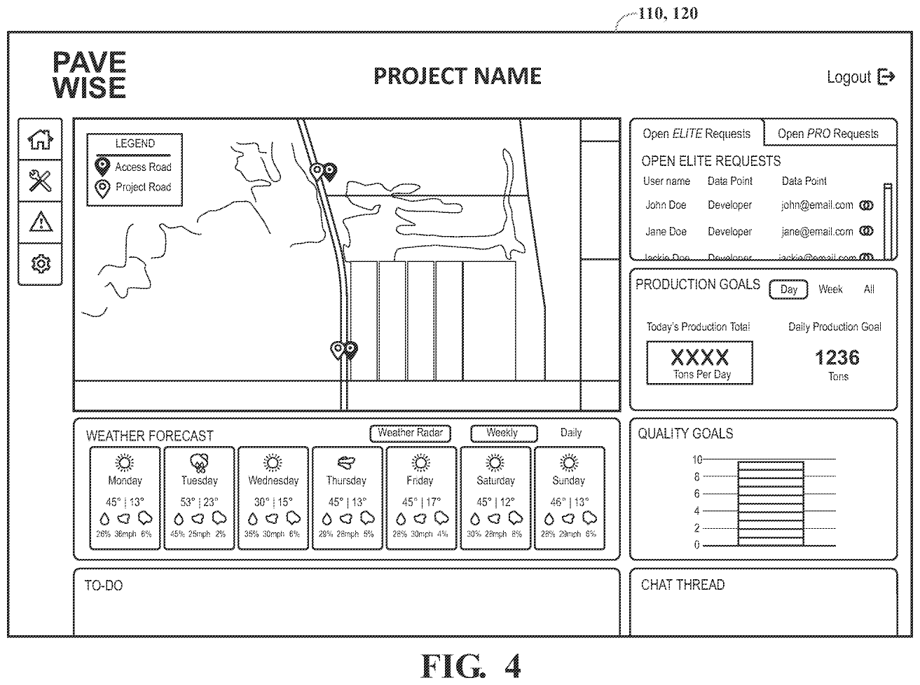

The parsed weather forecast data is utilized by the productivity forecast engine 220 of the proactive road construction recommendations application 102 to, for example, generate a 7-day productivity outlook average 310. The 7-day productivity outlook average 310 and associated calendar view 402 may be displayed by the client-facing website 110, and/or the client-facing mobile app 120 (FIGS. 4, 14 and 15).

The parsed weather forecast data may also be used to determine, for example, a daily view 410, a 7-day view 412, a 14-day view 414, and/or other time period. The daily view 410 may, for example, include a weather overview for each road construction project 502, a current real time forecast 504 and/or a productivity recommendation 506 which may be generated by the productivity forecast engine 220.

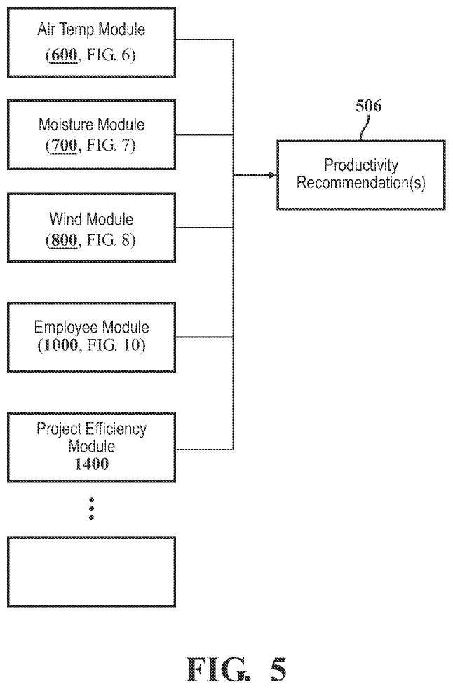

The productivity recommendation 506 may be determined with respect to the 7-day view 412, and the 14-day view 414 for display on the client-facing website 110, and/or the client-facing mobile app 120 (FIG. 4). That is, the productivity recommendation 506 may be used by the productivity forecast engine 220 (FIG. 5) which are then utilized by the notification interface 230 to generate notifications for the user via the client-facing website 110, and/or the client-facing mobile app 120.

With reference to FIG. 4, the client-facing website 110 and/or the client-facing mobile app 120 may provide features to the user that allow identification of the road construction project R. The geographic location of the road construction project R may be selected on a map, identified via coordinates, latitude longitude coordinates, etc. Various other monitoring features such as requests, production goals, quality goals, etc. may be displayed.

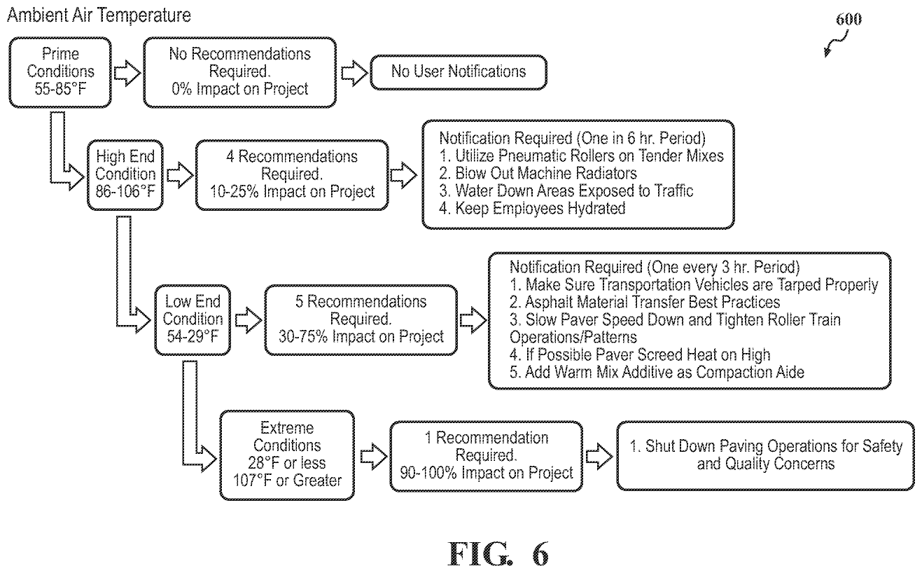

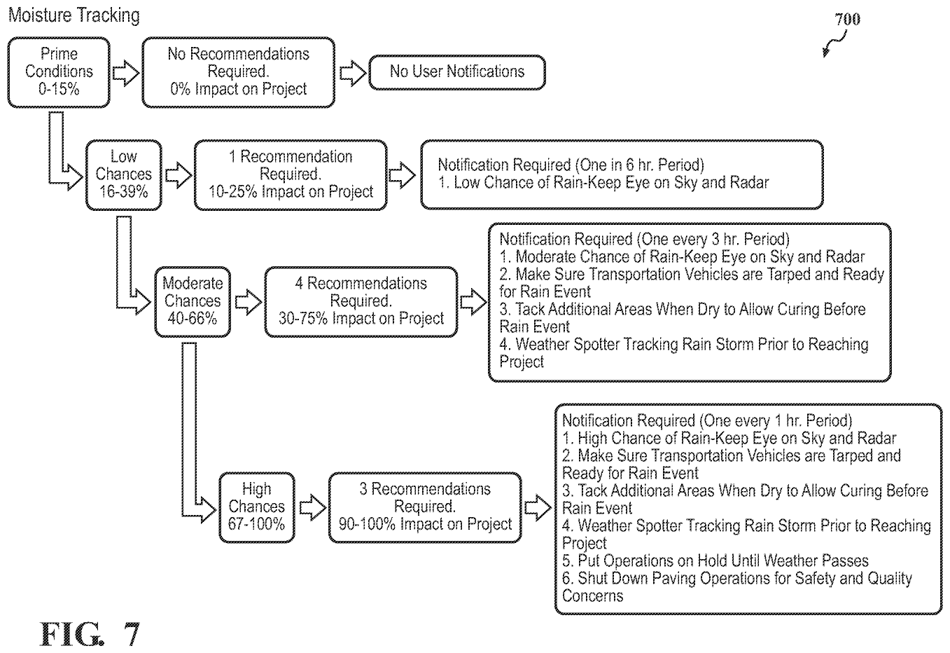

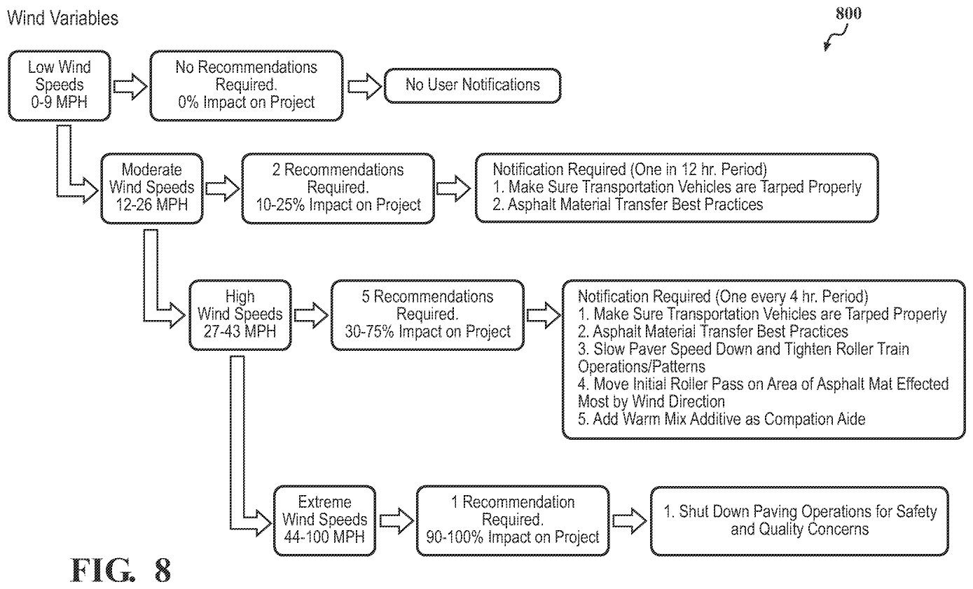

With reference to FIG. 5, the productivity recommendation 506 may include numerous tracking predictions and associated notifications for use by the productivity forecast engine 220. In one embodiment, the productivity recommendation 506 may track each of numerous weather events for each road construction project R via particular modules, e.g., an ambient air temperature module 600 (FIG. 6), a moisture module 700 (FIG. 7), a wind speed module 800 (FIG. 8), etc. appropriate to the particular road construction project R (e.g., pavement, asphalt, dirt road grading, etc.) then generate particular notifications associated therewith.

In one embodiment, the productivity recommendation 506 may generate notifications based on the most extreme weather event, the event most pertinent to the particular road construction project, and/or may combine the notifications to provide a resultant productivity recommendation 506 that may be used by the productivity forecast engine 220. The productivity recommendation 506 advantageously provides recommendations to assure efficient performance of the road construction project.

With reference to FIG. 6, the ambient air temperature module 600 ranks a temperature range for use by the productivity forecast engine 220. A prime temperature range (e.g., 55F-85F) is used to determine that such predicted weather condition change has 0% impact on one or more productivity variables associated with the project and thus results in no particular recommendation.

A high-end temperature range (e.g., 86F-106F) is used to determine that such predicted weather condition change has a 10-25% impact on one or more productivity variables associated with the project and results in 4 recommended notifications. The recommendations may include, for example, 1. utilize pneumatic rollers on tender mixes, 2. blow out machine radiators, 3. water down areas exposed to traffic and 4. keep employees hydrated. The notifications may be provided every 6-hour period prior to the predicted weather events. Typically, notifications are sent out daily in the morning or 2 hours prior to predicted weather condition change.

A low-end temperature range (e.g., 29F-54F) is used to determine that such predicted weather condition change has a 30-75% impact on one or more productivity variables associated with the project and results in 5 recommended notifications. The recommendations may include, for example, 1. make sure transportation vehicles are properly tarped, 2. asphalt material transfer best practices, 3.slow paver speed down and tighten roller train operations/patterns, 4. if possible paver screed heat on high, and 5. add warm mix additive as compaction aide. The notifications may be provided every 3-hour period prior to the predicted weather events.

An extreme temperature range (e.g., less than 28F or greater than 107F) is used to determine that such predicted weather condition change has a 90-100% impact on one or more productivity variables associated with the project and results in a notification to shut down the road construction project.

With reference to FIG. 7, the moisture module 700 ranks a moisture range for use by the productivity forecast engine 220. A prime moisture range (e.g., 0-15%) results in no recommendations and is used to determine that such predicted weather condition change has a 0% impact on one or more productivity variables associated with the project.

A low chance of moisture (e.g., 16-39%) is used to determine that such predicted weather condition change has a 10-25% impact on the project and results in 1recommended notification. The recommendations may include, for example, 1. watch radar. The notifications may be provided every 6-hour period prior to the predicted weather events.

A moderate chance of moisture (e.g., 40-60%) is used to determine that such predicted weather condition change has a 30-75% impact on one or more productivity variables associated with the project and results in 4 recommended notifications. The recommendations may include, for example, 1. watch radar, 2. make sure transportation vehicle are properly tarped, 3. tack additional areas when dry to allow curing before rain event, 4. track weather prior to reaching project. The notifications may be provided every 3-hour period prior to the predicted weather events.

An extreme chance of moisture (e.g., 67-100%) is used to determine that such predicted weather condition change has a 90-100% impact on one or more productivity variables associated with the project and results in a notification to shut down the road construction project as well as other recommendations. The recommendations may include, for example, 1. Watch radar, 2. make sure transportation vehicles are properly tarped, 3. Tack additional areas when dry to allow curing before rain event, 4. track weather prior to reaching project, 5. put operations on hold, 6. shut down operations, 6. Shut down paving operations. The notifications may be provided every 1-hour period prior to the predicted weather events.

With reference to FIG. 8, the wind speed module 800 ranks a wind speed range for use by the productivity forecast engine 220. A low wind speed range (e.g., 0-9 MPH) is used to determine that such predicted weather condition change has a 0% impact on one or more productivity variables associated with the project and results in no recommendations.

A moderate wind speed range (e.g., 12-26 MPH) is used to determine that such predicted weather condition change has a 10-25% impact on one or more productivity variables associated with the project and results in 2 recommended notifications. The recommendations may include, for example, 1. transportation vehicles are properly tarped, 2. asphalt material transfer best practices are followed. The notifications may be provided every 12-hour period prior to the predicted weather events.

A high wind speed range (e.g., 27-43 MPH) is used to determine that such predicted weather condition change has a 30-75% impact on one or more productivity variables associated with the project and results in 5 recommended notifications. The recommendations may include, for example, 1. transportation vehicle are properly tarped, 2. Asphalt material transfer best practices are followed, 3. slow paver speed down and tighten roller train operations/patterns 4. move initial roller pass on area of asphalt mat affected most by wind direction, 5. add warm mix additive as compaction aide. The notifications may be provided every 4-hour period prior to the predicted weather events.

An extreme wind speed range (e.g., 44-100 MPH) is used to determine that such predicted weather condition change has a 90-100% impact on one or more productivity variables associated with the project and results in a notification to shut down the road construction project.

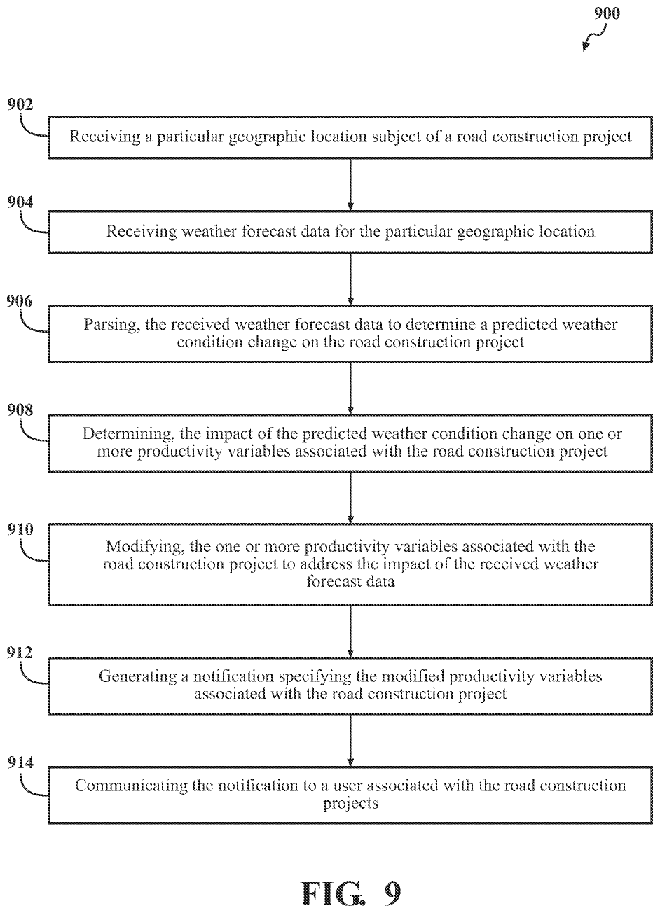

With reference to FIG. 9, a method 900 for modifying one or more productivity variables associated with a road construction project in response to forecasted weather events via the proactive road construction recommendations application 102 is disclosed in terms of functional block diagrams. The functions are programmed software routines and executable instructions capable of execution in various microprocessor-based electronics control embodiments such as the server 100 that are schematically represented herein as block diagrams.

In some embodiments, client input data 210 such as geographic locations of the road project, type of road application, types of equipment, workers, etc., can be uploaded to the server 100 via the client-facing website 110, and/or the client-facing mobile app 120. Alternatively, a user may instruct the server 100 to connect directly with a client database via a web services connection to retrieve client data.

Once the server 100 based proactive road construction recommendations application 102 receives the client input data (902), and receives weather forecast data (904), the proactive road construction recommendations application 102 can parse the client input data 210 as well as the weather forecast data from weather application programming interface 200 (906). That is, the proactive road construction recommendations application 102 parses the received weather forecast data to determine the impact of the predicted weather condition change on the associated road construction project.

The proactive road construction recommendations application 102 then determines the expected impact of the received weather forecast data via the productivity forecast engine 220 and database 130 associated with the particular road construction project (908). That is, the proactive road construction recommendations application 102 determines the likely impact upon the particular road construction project utilizing, for example, data from prior road construction projects stored in the database 130. The database 130 may contain data from prior road construction projects that includes, for example, historical weather conditions, modifications to one or more productivity variables taken at the time, the resultant delays, costs, equipment used, etc. The database 130 may also contain data regarding ideal productivity variables associated with the road construction project to address the expected impact of weather as well as other conditions that are analyzed by the server 100 in the context of the client input data 210 as well as the expected future weather in relation to the type of road construction project.

The proactive road construction recommendations application 102 then determines modifications (910) to one or more productivity variables associated with the road construction project to address the impact of the received weather forecast data.

The proactive road construction recommendations application 102 may thereafter generate notifications (912) for each user specifying the modified productivity variables associated with the road construction project for each road construction project.

The proactive road construction recommendations application 102 then utilizes the notification interface 230 to communicate the notification to a user associated with the road construction projects (914). The notification interface 230 may communicate with the client-facing systems at specific time periods and repeat such notifications at a determined repetition rate via mobile push notification services and email. The client-facing systems can also send requests and receive responses from the proactive road construction recommendations application 102.

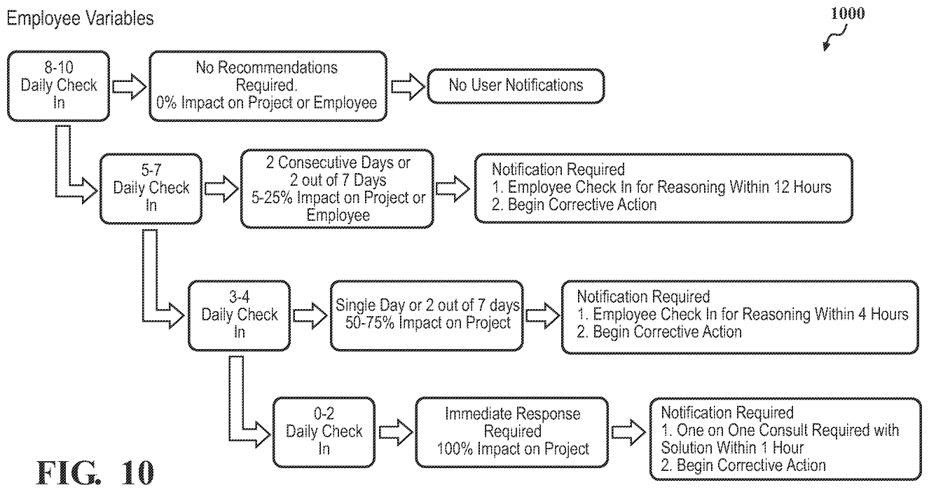

With reference to FIG. 10, in another embodiment, an employee diagnostics module 1000 allows employees to check in daily to monitor mental health and wellbeing to prevent burnout and keep employees safe. Workers in the road construction industry are typically considered “tough” and do not readily talk about feelings. However, applicant has determined that a communication platform via the proactive road construction recommendations application 102 that uses a text or email communication results in a more truthful indication of the worker's condition as they do not then feel “judged” or “pressured”.

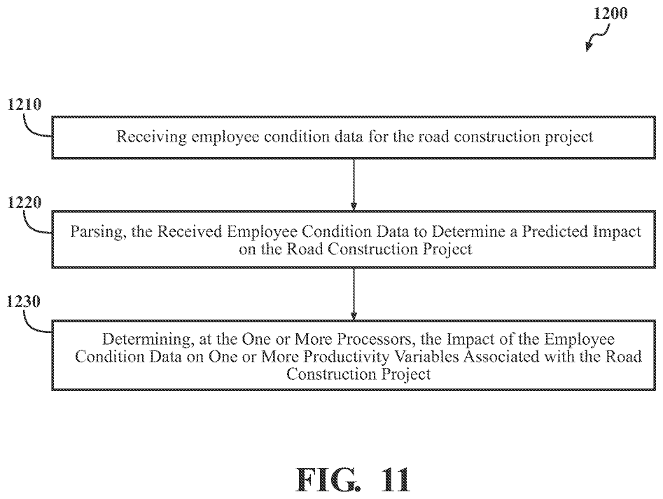

With reference to FIG. 11, a method 1200 for modifying one or more productivity variables associated with a road construction project in response to the employee diagnostics module 1000 via the proactive road construction recommendations application 102 is disclosed in terms of functional block diagrams. The functions are programmed software routines and executable instructions capable of execution in various microprocessor-based electronics control embodiments such as the server 100 that are schematically represented herein as block diagrams. The method 1200 may be integrated into the method 900 (FIG. 9) or may be performed as a standalone method as an employee diagnostics center that is in communication with the method 900 such as at step 910.

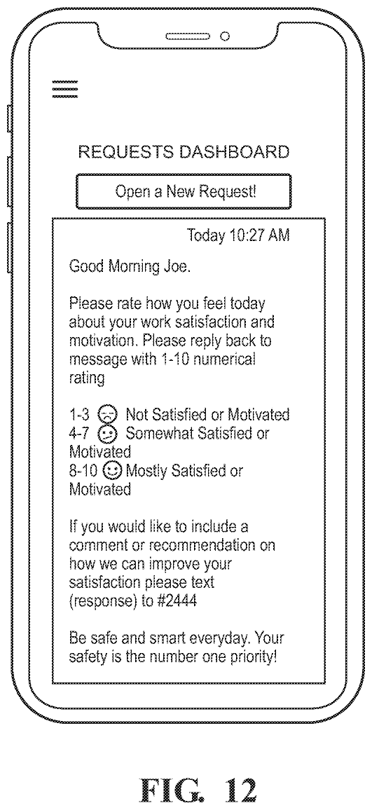

In one embodiment, the notification interface 230 may be utilized to communicate with each employee on each particular road construction project. The communication (1210) with each of the multiple of employees for the road construction project may include communicating a check the box answer question, a choose a number on a scale from 1-10 question, or other such readily response type question (FIG. 12). That is, a simple question has been found more likely to receive a response.

The employee diagnostics module 1000 (FIG. 5) ranks the severity of the employee condition data for each of the multiple of employees for the particular road construction project by the productivity forecast engine 220 (1220). The severity of the employee condition data for each of the multiple of employees for the road construction project may be determined in response to an employee condition rank provided by the employee and a consecutive number of occurrences at that rank. That is, each employee may rank his condition and the employee condition data may include the rank as well as the frequency of the rank over a week or other such time period.

In one example, each employee is requested to rank his condition via a 0-10 out of a 10 scale. The employee response is thus readily provided each day in a simple question answer format. The question may be as simple as “How is your work motivation today?” A single question may be asked, or a question tree may be provided which depends on prior questions to further elucidate each employee's motivation, situation, mental health, physical health, etc. “Are there any conflicts you have with anyone you are working with?” “What would improve your motivation today?”

In one embodiment, an 8-10 out of 10 employee condition rank employee condition rank (e.g., 0% impact) results in no recommendations for that employee.

A 5-7 out of 10 employee condition rank (e.g., 5-25% impact) results in an associated notification that includes a first multiple of recommendations. The 5-7 out of 10 employee condition rank may, for example, be required to have occurred for two consecutive days or two out of seven days in the week. The first multiple of recommendations may include employee check-in for reasoning within 12 hours and a plan to begin corrective actions.

A 3-4 out of 10 employee condition rank (e.g., 50-75% impact) results in an associated notification that includes a second multiple of recommendations. The 3-4 out of 10 employee condition rank may, for example, be required to have occurred for two consecutive days or two out of seven days in the week. The second multiple of recommendations may include employee check-in for reasoning within 4 hours and a plan to begin corrective actions.

A 0-2 out of 10 employee condition rank (e.g., 100% impact) results in an associated notification that includes a third multiple of recommendations. The 0-2 out of 10 employee condition rank may, for example, be required to have an immediate response. The third multiple of recommendations may include a one-on-one consultation with a solution within one hour and a plan to begin corrective actions.

The proactive road construction recommendations application 102 then determines the expected impact of the received employee condition rank data via the productivity forecast engine 220 and database 130 associated with the particular road construction project (1230) as detailed above (908).

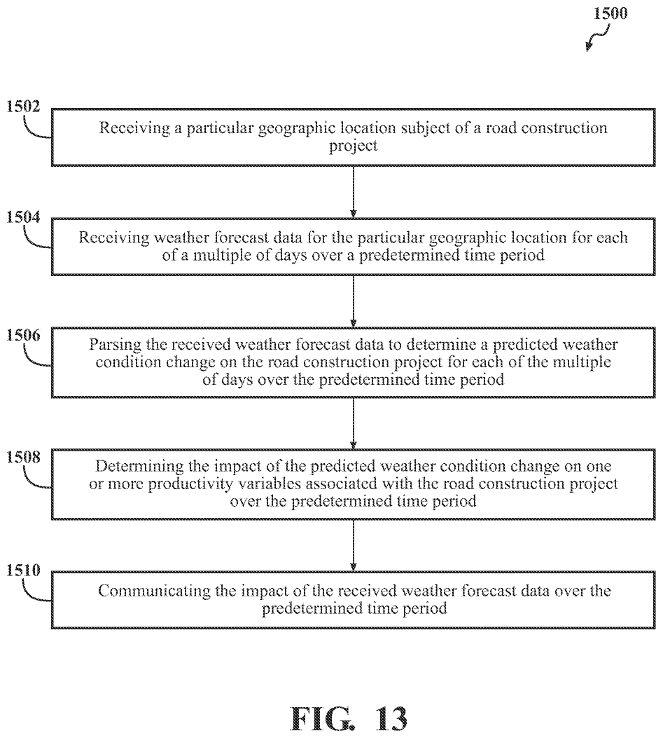

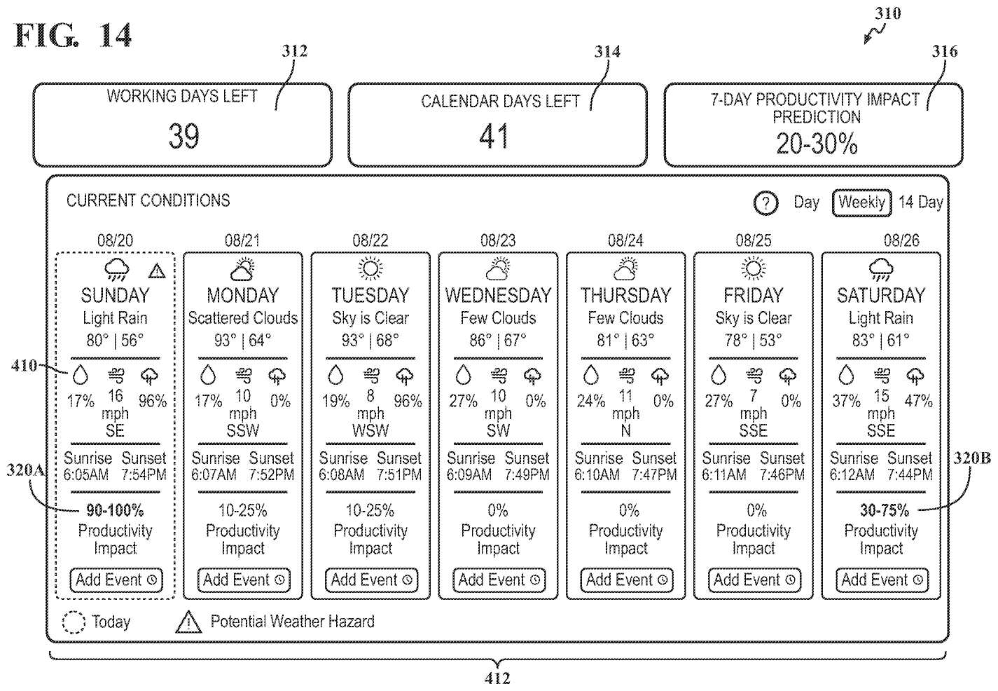

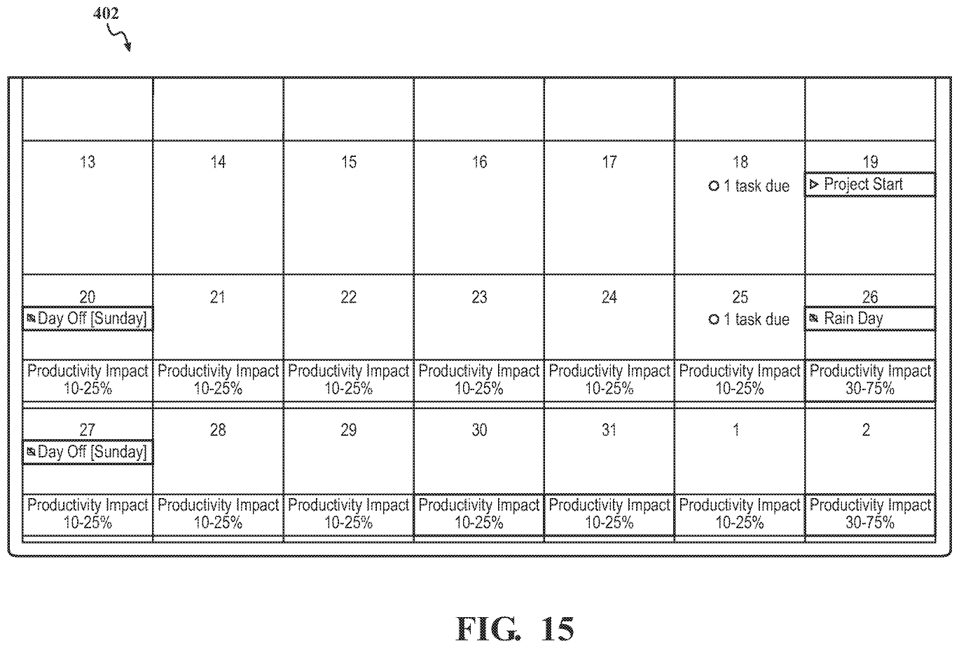

With reference to FIG. 13, in another embodiment, a project efficiency module 1400 (FIG. 5) determines an overall productivity impact prediction 316 over a predetermined time period in response to forecasted weather events. The project efficiency module 1400 (FIG. 5) may utilize the parsed weather forecast data with the productivity forecast engine 220 (FIG. 4) of the proactive road construction recommendations application 102 to, for example, generate the productivity outlook average 310 (FIG. 14) and associated calendar view 402 (FIG. 15) that may be displayed by the client-facing website 110, and/or the client-facing mobile app 120 (FIG. 4).

A method 1500 for determining the overall productivity impact prediction 316 (FIG. 14) over a predetermined time period e.g., 7 days, 14 days, etc. associated with a road construction project in response to forecasted weather events with the project efficiency module (FIG. 5) and via the proactive road construction recommendations application 102, is disclosed in terms of functional block diagrams. The method 1500 may be integrated into the method 900 (FIG. 9) or may be performed as a standalone method.

The functions of the method 1500 are programmed software routines and executable instructions capable of execution in various microprocessor-based electronics control embodiments such as the server 100, etc. As generally described above, in some embodiments, client input data 210 such as geographic locations of the road project, type of road application, types of equipment, workers, etc., can be uploaded to the server 100 via the client-facing website 110, and/or the client-facing mobile app 120. Alternatively, a user may instruct the server 100 to connect directly with a client database via a web services connection to retrieve client data.

Once the server 100 based proactive road construction recommendations application 102 receives the client input data (1502), and receives weather forecast data (1504), as also generally described above, the proactive road construction recommendations application 102 can parse the client input data 210 as well as the weather forecast data from weather application programming interface 200 (1506). That is, the proactive road construction recommendations application 102 parses the received weather forecast data to determine the impact (1508) of the predicted weather condition change on the associated road construction project over a predetermined time period.

The predetermined time period may be 7 days, 14 days, etc. as received from weather forecast data (1504). The greater the time in advance, the less reliable the weather forecast data may be and such data may be assigned a reduced confidence value. The predetermined time period may also be associated with a number of working days left 312 and a number of calendar days left 314 in the project.

The overall productivity impact prediction 316 of the received weather forecast data over the predetermined time period may be communicated 1510 via the 7-day productivity outlook average 310 and the associated calendar view 402 may be displayed by the client-facing website 110, and/or the client-facing mobile app 120 (FIGS. 4, 14 and 15). The client-facing website 110, and/or the client-facing mobile app 120 may, for example, provide a selectable daily view, week view, 14-day view, and/or other predetermined time period.

The overall productivity impact prediction 316 may be implemented to provide

users with a general overview of how efficient/effective they will be on the specific project(s) for the upcoming work week. The overall productivity impact prediction 316 allows the user to make proactive decisions with crews and operations in response to potential project risk. When a project impact is higher, the chance of increased project risk or inefficiencies increases while quality on the project decreases and can cause lost time and profits. As an example, if the user has three (3) projects that are being performed at a 10% rating, a 20% rating, and a 30% rating as determined by the overall productivity impact prediction 316, the user can understand the upcoming risk associated with each individual project to determine where to concentrate workforce, equipment, operations, etc., to make the overall projects as a whole more efficient. That is, relatively minor differences are determined and ranked such that if the user places all the workforce on the project that has a 30% rating, we can expect that there is a higher risk associated with this project to hit weekly production goals, quality incentives and the amount of increased downtime/idle time for the impact will cause lost time and profits. The overall productivity impact prediction 316 allocates operations to the places/projects where they can be most effective or successful to achieve quality in the environmental conditions presented and thereby controlled.

The overall productivity impact prediction 316, permits crews working on a project that is only going to present 10% risk compared to 30%. Applicant has determined that crews use the overall productivity impact prediction 316 to determine upcoming working schedules and determine proactive operational changes to move crews around and minimize the overall risk associated with each of a multiple of individual projects. This data also assists the users in identifying how this impact may affect the upcoming schedule as far as working days, calendar days and completion dates. Applicant has determined that the overall productivity impact prediction 316 provides for decreased project schedule lag of a company's entire project portfolio by 16% when used to plan and implement work on projects with the lower impact ratings.

In one embodiment, the 7-day productivity outlook average 310 may provide daily views 410 of the 7-day view 412, each with a productivity impact prediction percentage 320A-320G. The productivity impact prediction percentage 320A-320G for each day may be a daily amalgamation of the productivity impact from the particular modules, e.g., the ambient air temperature module 600 (FIG. 6), the moisture module 700 (FIG. 7), the wind speed module 800 (FIG. 8), etc. as determined by the productivity forecast engine 220. That is, the productivity impact is determined for each day based on that day's forecasted weather.

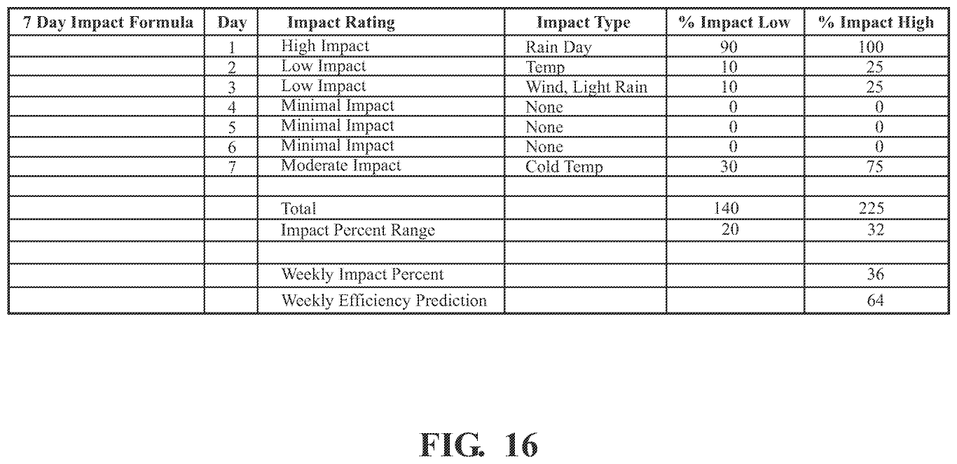

The overall productivity impact prediction 316 of the received weather forecast data may be determined from the daily amalgamation of the productivity impact for the predetermined time period, e.g., 7 days. In one example shown in FIG. 16, the overall productivity impact prediction 316 of the received weather forecast data over the predetermined time period may be determined as a high/low percentile average of the daily high/low productivity average divided by the predetermined time period, e.g., 7 days.

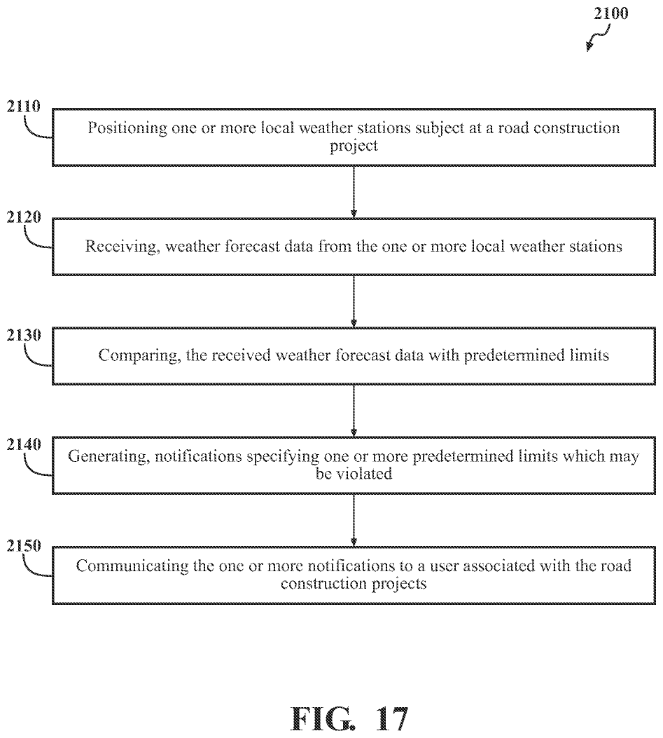

With reference to FIG. 17, in another embodiment, a method 2100 for identifying weather related productivity impact events to a road construction project predetermined weather limits is schematically illustrated. The method 2100 may be integrated into any of the methods disclosed above or may be performed in a standalone manner.

The functions of the method 2100 are programmed software routines and executable instructions capable of execution in various microprocessor-based electronics control embodiments such as the server 100, etc. As generally described above, in some embodiments, client input data 210 such as geographic locations of the road project, type of road application, types of equipment, workers, etc., can be uploaded to the server 100 via the client-facing website 110, and/or the client-facing mobile app 120. Alternatively, a user may instruct the server 100 to connect directly with a client database via a web services connection to retrieve client data.

Initially, one or more local weather stations 2000 may be positioning at the particular geographic location that is the subject of a road construction project R (step 2110). Depending on the area of the road construction project R, the number of local weather stations 2000 and their geometric relationship may be allocated so that the local weather stations 2000 provide overlapping coverage. Alternatively, or in addition, the local weather stations 2000 may be spaced in critical areas of the road construction project.

Once emplaced, the one or more local weather stations 2000 transmit real time weather data (step 2120) which is received by the proactive road construction recommendations application 102 (step 2120). The one or more local weather stations 2000 may also log the sensed weather data.

The local weather station 2000 assure an accurate on-the-site weather determination and may communicate directedly, via the internet, with the server 100 that runs the proactive road construction recommendations application 102 to provide a self-contained system. The local weather station 2000 provides hyperlocal and thereby accurate real time weather data. The hyperlocal weather data may be used, for example, to prove that environmental factors impacted and/or prevented project timeline/completion.

The proactive road construction recommendations application 102, in this embodiment, may compare the received weather forecast data with predetermined weather limits (step 2130). The predetermined weather limits may include, for example, local, state, federal, and/or international standards and codes for predetermined weather limits during construction projects that have been previously stored in the database 130. The predetermined weather limits may be defined based on the geographic location of the road construction project, i.e., the codes to which the road construction project must comply. Next, the proactive road construction recommendations application 102 may generate one or more notifications specifying one or more predetermined weather limits which is violated by the received weather forecast data (step 2140). Alternatively, or in addition, the proactive road construction recommendations application 102 may log any weather events that are violative of the predetermined weather limits.

The proactive road construction recommendations application 102 may communicate the one or more notifications to a user associated with the road construction projects (step 2150).

The proactive road construction recommendations application 102 operates in a bottom to top methodology to provide a project diagnostics center that provides a snapshot of the overall project as well as an overall employee diagnostics center to show employee health across all projects for the administrator. By having the data available to determine a productivity impact for a predetermined time period, overall performance on projects may be improved by, for example, shifting resources from one construction site to another.

The proactive road construction recommendations application 102 maintains road construction project quality at a maximum while being as efficient as possible with current and future weather conditions. Weekly, daily, and hourly weather tracking keeps the user notified when working conditions are not optimal through proactive notifications.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure.

Although the different non-limiting embodiments have specific illustrated components, the embodiments of this invention are not limited to those particular combinations. It is possible to use some of the components or features from any of the non-limiting embodiments in combination with features or components from any of the other non-limiting embodiments.

The foregoing description is exemplary rather than defined by the limitations within. Various non-limiting embodiments are disclosed herein, however, one of ordinary skill in the art would recognize that various modifications and variations in light of the above teachings will fall within the scope of the appended claims. It is therefore to be appreciated that within the scope of the appended claims, the disclosure may be practiced other than as specifically described. For that reason the appended claims should be studied to determine true scope and content.

What is claimed is:

1. A computer implemented method for identifying weather related productivity impact events to a road construction project, comprising:
positioning one or more local weather stations at a particular geographic location that is the subject of a road construction project;
receiving, at one or more processors, weather data from the one or more local weather stations;
comparing, at the one or more processors, the received weather data with one or more predetermined weather limits;
generating, using the one or more processors, one or more notifications specifying one or more predetermined weather limits violated by the received weather data; and
communicating the one or more notifications to a user associated with the road construction projects.

2. The method as recited in claim 1, wherein the received weather data comprises at least one of solar radiation, precipitation, max air temperature, minimum air temperature, barometric pressure, vapor pressure, relative humidity, wind speed, wind direction, maximum wind gust.

3. The method as recited in claim 1, further comprising logging the predetermined weather limits violated by the received weather data.

4. The method as recited in claim 1, further comprising parsing the received weather data with respect to a type of road application.

5. The method as recited in claim 4, wherein the type of road application comprises one of asphalt, pavement, or dirt road grading.

6. The method as recited in claim 1, wherein the predetermined weather limits are set by a regulatory agency.

7. The method as recited in claim 6, wherein the predetermined weather limits are scraped from a third-party data source.

8. The method as recited in claim 6, wherein the predetermined weather limits comprise at least one of a local, state, or federal regulatory agency.

9. The method as recited in claim 1, wherein the predetermined weather limits are stored in a database in communication with the one or more processors.

10. The method as recited in claim 1, further comprising visually recording weather data from the one or more local weather stations.

11. The method as recited in claim 1, wherein the notifications comprise identification of the one or more predetermined weather limits that are violated by the received weather data.

12. A system for identifying weather related productivity impact events to a road construction project, comprising:
a local weather station at a particular geographic location that is the subject of a road construction project;
a database operable to store predetermined weather limits set by a regulatory agency for the road construction project; and
a server located at a location remote from the road construction project, the server runs a proactive road construction recommendations application that communicates with the local weather station and the database to processes weather information from the local weather station to identify one or more predetermined weather limits violated by the received weather data.

13. The system as recited in claim 12, further comprising a client-facing website to provide advanced notice of weather events and directions for modifying one or more productivity variables associated with the road construction project in response to the projected weather.

14. The system as recited in claim 12, further comprising a client-facing mobile app to provide advanced notice of weather events and directions for modifying one or more productivity variables associated with the road construction project in response to the projected weather.

15. The system as recited in claim 12, wherein the local weather station comprises a camera.
